(19) United States
(12) Patent Application Publication
(10) Pub. No.: US 2012/0207333 A1
(43) Pub. Date: Aug. 16, 2012

(54) Sound Box

(76) Inventor: Tzu-Chung Chang, NiaoSong Township (TW)

(21) Appl. No.: 13/027,348

(22) Filed: Feb. 15, 2011

(51) Int. Cl. H04R 5/02

(52) U.S. Cl. 381/306

(57) ABSTRACT

A sound box includes a tweeter, a mid-range speaker, a woofer, an infrared receiver, a LED displayer and an integral module. The infrared receiver receives a control signal. The LED displayer is connected to the infrared receiver. The integral module includes a processor, an audio input port, a stereo audio input port, an USB input port, a video output port, a power amplifier, an output port and a control module. The USB input port is connected to the processor. The video output port is, connected between the processor and a displayer. The power amplifier has an output port and is connected to the tweeter, mid-range speaker, woofer, infrared receiver and LED displayer. The audio output port sends signals from the audio input port, stereo audio input port, USB input port and processor to the power amplifier which generates an amplified signal. The control module is connected to the power amplifier.

### BACKGROUND OF THE INVENTION

1. Field of the Invention

The present invention generally relates to a sound box and, more particularly, to a sound box having audio and video functions.

2. Description of the Related Art

A conventional sound box generally includes a tweeter 1, a mid-range speaker 2 and a woofer 3 as shown in FIG. 1. Although this sound box does provide better sound quality than TV speakers, it can only play audio signals rather than both audio and video signals retrieved from devices such as portable hard drives or flash drives, limiting the usage thereof. In light of this, the invention provides a novel sound box which improves upon the conventional sound box while providing good sound quality. The sound box of the invention provides multiple input and output interfaces, allowing audio signals of DVD, TV, MP3, MP4, iphone, ipad or music cell phone, as well as audio, video and image signals of computers, portable hard drives or flash drives, to be input in the sound box through the input interfaces. At the same time, the output interfaces of the sound box are connected to external devices to play the audio and video signals. Furthermore, the sound box of the invention has optimized internal circuits with simpler wiring for audio and video playing.

### SUMMARY OF THE INVENTION

It is therefore the primary objective of the invention to provide a sound box having multiple audio and video interfaces for receiving audio signals from devices such as DVD, TV, MP3, MP4, iphone, ipad or music cell phone, as well as audio, video and image signals from devices such as computer, portable hard drive and flash drive.

Modern liquid crystal TVs are getting popular. However, the liquid crystal TVs do not provide good sound quality, requiring external sound boxes for better sound quality. In light of this problem, the invention provides a sound box which not only produces good sound quality but also provides more functions than the conventional sound box. The sound box of the invention provides multiple input and output interfaces, allowing audio signals of DVD, TV, MP3, MP4, iphone, ipad or music cell phone, as well as audio, video and image signals of computers, portable hard drives or flash drives, to be input in the sound box through the input interfaces. At the same time, the output interfaces of the sound box are connected to external devices to play the audio and video signals. Furthermore, the sound box of the invention has optimized internal circuits with simpler wiring for audio and video playing.

The invention discloses a sound box including a tweeter, a mid-range speaker, a woofer, an infrared receiver, a LED displayer and an integral module. The infrared receiver receives a control signal. The LED displayer is electrically connected to the infrared receiver. The integral module includes a processor, at least one audio input port, a stereo audio input port, an USB input port, a video output port, a power amplifier, at least one audio output port and a control module. The USB input port is electrically connected to the processor. The video output port is electrically connected between the processor and a displayer. The power amplifier has an output port and is electrically connected to the tweeter, mid-range speaker, woofer, infrared receiver and LED displayer. The audio output port sends signals from the audio input port, stereo audio input port, USB input port and processor to the power amplifier for amplification, wherein the power amplifier amplifies the received signals to generate an amplified signal that is sent to the tweeter, mid-range speaker and woofer via the output port thereof. The control module is electrically connected to the power amplifier, wherein audio, video or image signals are received via the audio input port, stereo audio input port and USB input port, and the audio output port and video output port are connected to an external device so as to replay the audio, video or image signals.

### BRIEF DESCRIPTION OF THE DRAWINGS

The present invention will become more fully understood from the detailed description given hereinafter and the accompanying drawings which are given by way of illustration only, and thus are not limitative of the present invention, and wherein:

FIG. 1 shows a conventional sound box.

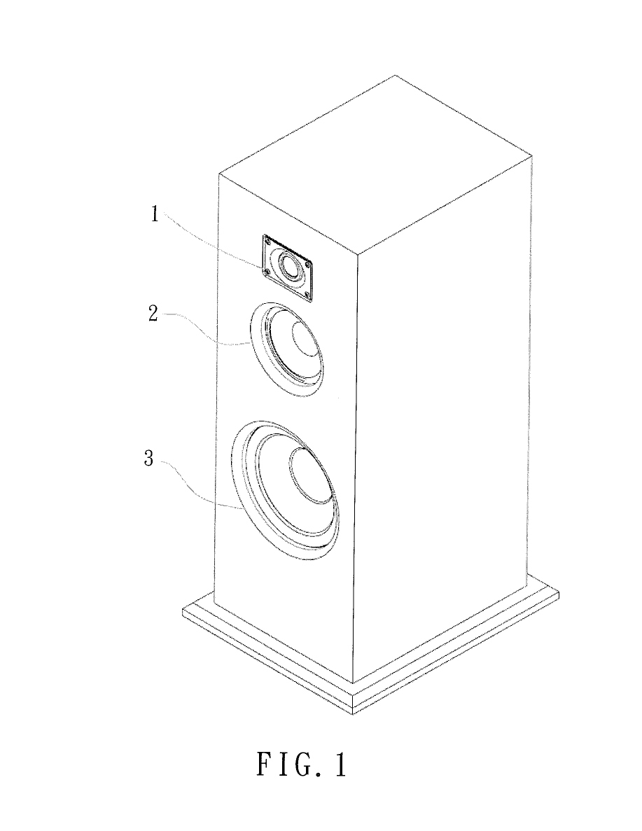

FIG. 2 shows a side view of a sound box of the invention.

FIG. 3 shows a rear view of the sound box of the invention.

FIG. 4 shows a diagram of internal components of the sound box of the invention.

In the various figures of the drawings, the same numerals designate the same or similar parts. Furthermore, when the term “first”, “second”, “third”, “fourth”, “inner”, “outer” “top”, “bottom” and similar terms are used hereinafter, it should be understood that these terms refer only to the structure shown in the drawings as it would appear to a person viewing the drawings, and are utilized only to facilitate describing the invention.

### DETAILED DESCRIPTION OF THE INVENTION

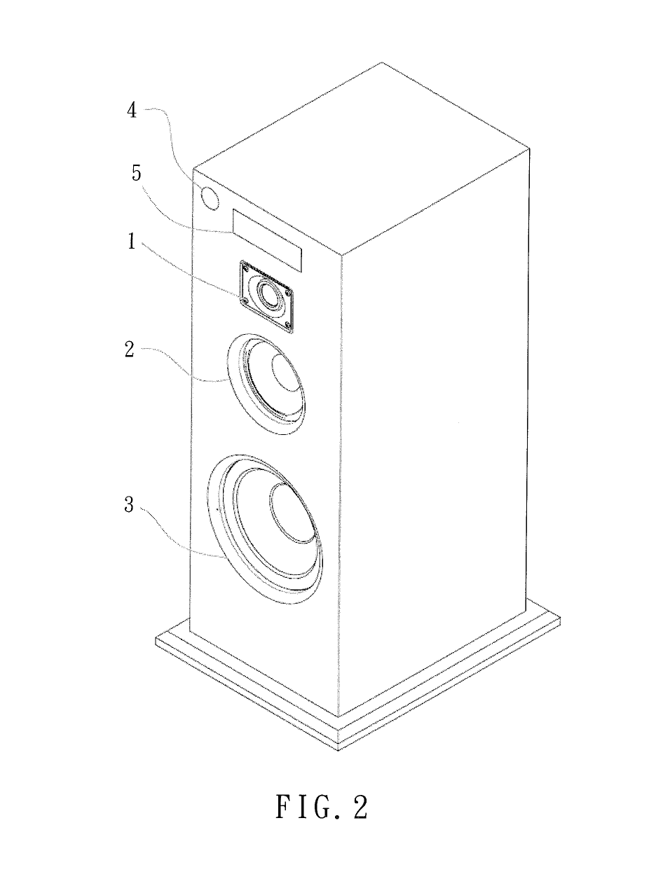

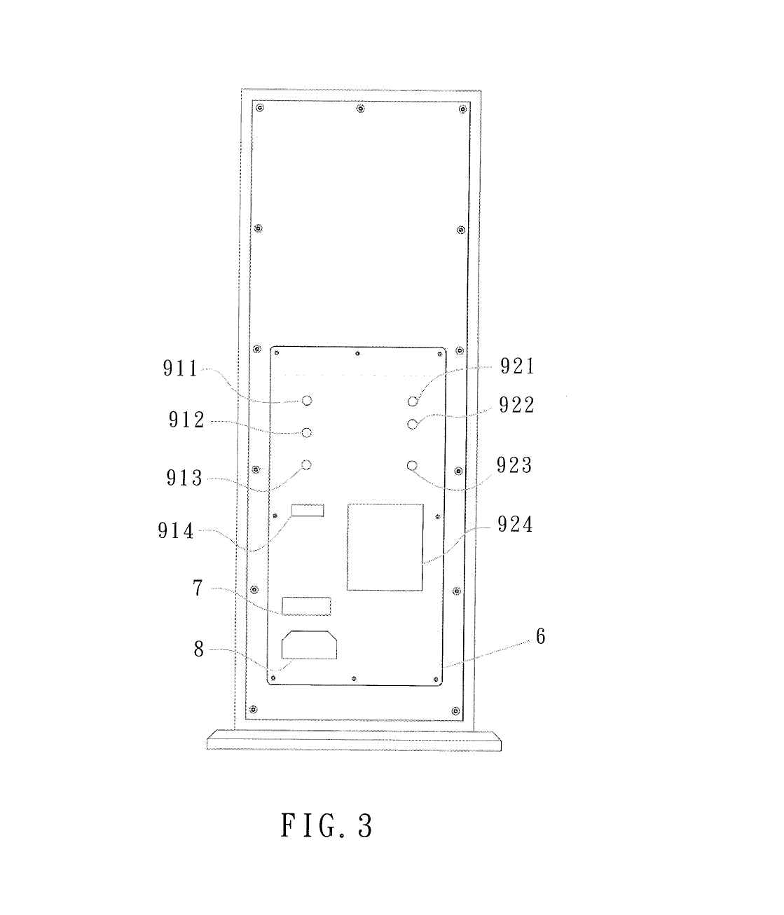

Referring to FIGS. 2 to 4, the sound box of the invention includes a tweeter 1, a mid-range speaker 2, a woofer 3, an infrared receiver 4, a LED displayer 5, a left audio input port 911, a right audio input port 912, a stereo audio input port 913, an USB input port 914, a left audio output port 921, a right audio output port 922, a video output port 923, a control module 924, a processor 925 and a power amplifier 926. An input audio signal is processed by an integral module 6 and the processed audio signal is sent to the tweeter 1, mid-range speaker 2 and woofer 3 for playing. The infrared receiver 4 receives a control signal transmitted by a remote control of the sound box. The LED displayer 5 displays a plurality of functions the sound box is capable of performing, and the control signal controls the sound box to operate in different status by choosing the functions to be played via the power amplifier 926.

The integral module 6 consists of the left audio input port 911, right audio input port 912, stereo audio input port 913, USB input port 914, left audio output port 921, right audio output port 922, video output port 923, control module 924, processor 925 and power amplifier 926. Thus, the integral module 6 allows the audio, video and image signals to be input in the sound box through various input interfaces thereof, and allows the processed audio and video signals to be played by external devices connected to the output interfaces thereof.

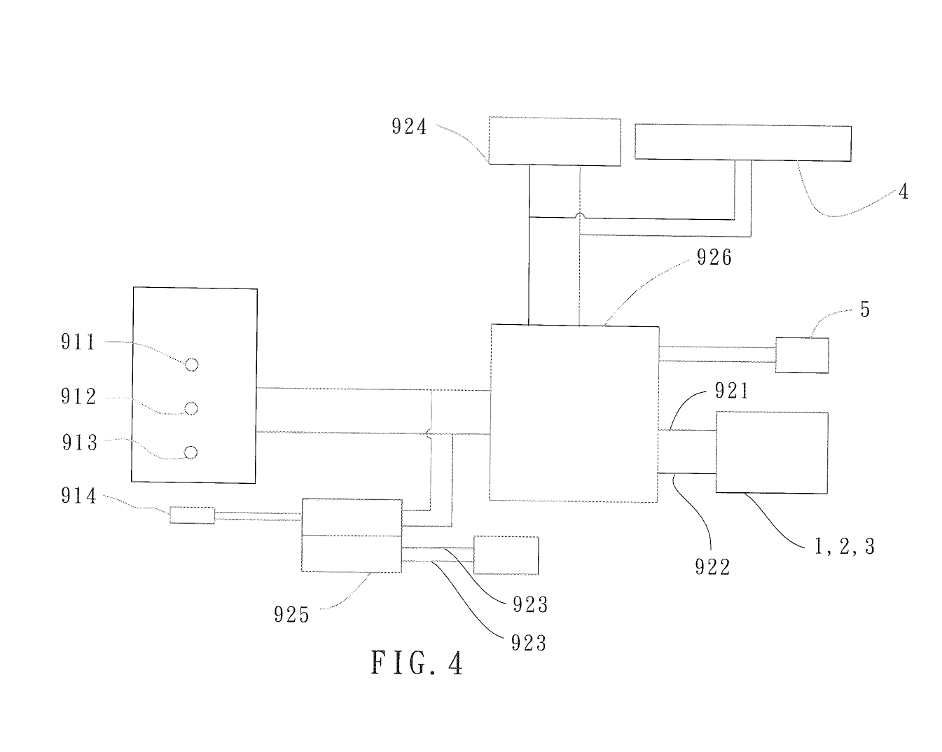

Referring to FIG. 4, the power amplifier 926 is electrically connected to the tweeter 1, mid-range speaker 2, woofer 3, infrared receiver 4 and LED displayer 5, wherein the power amplifier 926 has a calculation function. The left audio input port 911 and right audio input port 912 are audio input ports and can be connected to audio output ports of external devices such as TV, DVD and so on, so as to produce good-quality sound. The stereo audio input port 913 is a 3.5 mm stereo input port and can be connected to mainstream multimedia players such as MP3, MP4, iphone, music cell phone to replay the audio signals. The USB input port 914 is an input port for portable devices and is connected to the processor 925 which, in turn, processes the inputted audio and video signals. The processed audio and video signals are sent to the power amplifier 926 for amplification so that the amplified audio and video signals can be played by the tweeter 1, mid-range speaker 2 and woofer 3. The processor 925 can also send the processed video signals to displayers such as TV for displaying. The control module 924 is connected to the power amplifier 926 to activate the operation of the power amplifier 926. As such, the power amplifier 926 can perform a calculation based on signals received from the infrared receiver 4 and control module 924. When the USB input port 914 is connected to a computer, audio files of the computer can be played. In addition, audio, video and image signals of portable devices such as portable hard drives or flash drives can be input into the sound box. Based on this, the audio, video and image signals can be selectively chosen via a menu provided by the control module 924. As shown in FIG. 4, the left audio output port 921 and right audio output port 922 serve as audio output ports that send the signals from the left audio input port 911, right audio input port 912, stereo audio input port 913, USB input port 914 and processor 925 to the power amplifier 926 for amplification. The power amplifier 926 amplifies the received signals to generate an amplified signal (audio signal) that is sent to the tweeter 1, mid-range speaker 2 and woofer 3 via an output port of the power amplifier 926 for playing. The audio input port 911 and right audio input port 912 can be connected to other sound boxes to enhance the sound effects. In addition, the video output port 923 can be connected to displayers (such as TV or screen) via a video cable line to display the audio and video signals. The sound box of the invention not only has more functions than the conventional one, but also simplifies conventional hardware such as player, power amplifier and sound box, thus achieving great convenience.

The sound box of the invention not only allows audio signals to be input via the left audio input port 911, right audio input port 912 and stereo audio input port 913, but also allows audio, video and image signals to be input via the USB input port 914. As such, the left audio output port 921, right audio output port 922 and video output port 923 are connected to external devices to replay the audio, video or image signals. In conclusion, the sound box of the invention not only has both audio and video functions, but also allows inputting and outputting of both audio and video signals. Thus, easy usage of the sound box is provided.

Although the invention has been described in detail with reference to its presently preferable embodiment, it will be understood by one of ordinary skill in the art that various modifications can be made without departing from the spirit and the scope of the invention, as set forth in the appended claims.

What is claimed is:

1. A sound box, comprising:
a tweeter;
a mid-range speaker;
a woofer;
an infrared receiver receiving a control signal;
a LED displayer electrically connected to the infrared receiver; and
an integral module, comprising:
a processor;
at least one audio input port;
a stereo audio input port;
an USB input port electrically connected to the processor;
a video output port electrically connected between the processor and a displayer;
a power amplifier having an output port and electrically connected to the tweeter, the mid-range speaker, the woofer, the infrared receiver and the LED displayer;
at least one audio output port sending signals from the at least one audio input port, the stereo audio input port, the USB input port and the processor to the power amplifier for amplification, wherein the power amplifier amplifies the received signals to generate an amplified signal that is sent to the tweeter, the mid-range speaker and the woofer via the output port of the power amplifier for playing; and
a control module electrically connected to the power amplifier, wherein audio, video or image signals are received via the at least one audio input port, the stereo audio input port and the USB input port, and the at least one audio output port and the video output port are connected to an external device so as to replay the audio, video or image signals.

2. The sound box as claimed in claim 1, wherein the at least one audio input port includes a plurality of audio input ports.

3. The sound box as claimed in claim 1, wherein the at least one audio output port includes a plurality of audio output ports.

4. The sound box as claimed in claim 1, wherein the displayer is a TV or screen.
